(19) United States
(12) Patent Application Publication
(10) Pub. No.: US 2004/0109983 A1
(43) Pub. Date: Jun. 10, 2004

(54) Foamed roofing materials and methods of use

(76) Inventors: George E. Rotter, Naperville, IL (US); John L. Melquist, Naperville, IL (US); Robert B. Morland, Naperville, IL (US); Donald E. Rubis, Somonauk, IL (US)

Correspondence Address: BP America Inc., Docket Clerk, BP Legal, M.C. 5 East, 4101 Winfield Road, Warrenville, IL, 60555, US

(21) Appl. No.: 10/725,793

(22) Filed: Dec. 2, 2003

Related U.S. Application Data
(60) Provisional application No. 60/432,140, filed on Dec. 10, 2002.

(51) Int. Cl. B32B 1/00

(52) U.S. Cl. 428/143; 156/71; 428/317.1; 428/319.7

(57) ABSTRACT

Improvements in compositions, composites, and methods for construction of weather resistant and insulated roofs are disclosed. The type of roofs to which these improvements apply are typically known as built up roofs. Built up roofs feature a substrate as an inner layer normally adjacent to and attached to the exterior of an unimproved roof surface. This invention is directed to improved foamed resin substrates used in such roof constructions. Alternating layers of hot asphalt and roofing felt are applied to the foam substrate layer. In prior art roofs, the foamed resin substrates could not withstand the direct application of hot molten asphalt to the foam surface which necessitated use of an isolation layer between the foamed resin layer and the first asphalt layer. This invention discloses compositions, composites, and methods involving direct application of hot asphalt to specially formulated and thermally resistant polyester foam resin substrate layers at temperatures up to 500° F. These improved compositions, composites, and methods not only reduce labor and material costs but also produce roofs that score higher on standard tests used for rating such roofing constructions.

### RELATIONSHIP TO PRIOR APPLICATIONS

This application claims the benefit of U.S. provisional patent application Ser. No. 60/432,140 filed Dec. 10, 2002, entitled “FOAMED ROOFING MATERIALS AND METHODS OF USE.” provisional application Ser. No. 60/432,140 is hereby incorporated by reference in its entirety.

### FIELD OF THE INVENTION

This invention generally relates to improvements in compositions and methods for construction of weather resistant and/or insulated roofs. Typical prior art roofs to which these improvements apply are of the type comprising a substrate as an inner layer normally adjacent to and attached to the exterior of an unimproved roof. These prior art roofs typically further comprise one or several layers of asphalt normally applied with alternating layers of roofing felt and ending with a final asphalt layer that is exposed to the elements. This type of layered roof construction is typically known as a “built up roof” in the roofing art. This invention is directed to improvements in such built up roofs, particularly in the case where the substrate layer comprises a foamed thermoplastic resin.

### BACKGROUND OF THE INVENTION

The prior art in this area discloses the use of many different types of substrate materials that have been used as the primary layer in built up roofs. For this discussion, it is useful to divide these into two broad categories of substrate materials as follows; (1) foamed thermoplastic resins, and (2) other non-foamed materials. The principal advantage of foamed materials is their generally superior insulating properties over those of non-foamed substrates. The principal advantage of the non-foamed substrate materials, such as wood fiberboard, is their superior thermal stability and chemical stability that permits application of the first coat of molten asphalt directly to the substrate.

In built up roofing constructions, the asphalt is applied in the molten state typically at temperatures of about 235° C. (450° F.) or even higher. Prior art foamed resins are not suitable for the direct application of hot asphalt because of severe thermal degradation at such temperatures, chemical degradation arising from the solvent-like properties of the hydro carbonaceous materials present in the asphalt, or both. As such, in prior art foam substrate roofs; it was necessary to isolate the inner foam layer substrate from the direct application of the hot asphalt. Facing the foamed substrate with a material of superior thermal and chemical resistance, then subsequently applying the hot asphalt to the facing material frequently achieved the isolation of the foamed substrate. Therefore, the realization of the superior insulating qualities associated with use of a foamed substrate were achieved, but at the expense of higher material and labor costs because of the necessity to apply facing material to the foam prior to application of the first molten asphalt layer. What is needed is a foamed thermoplastic resin substrate to which hot asphalt in the molten state can be directly applied therefore retaining the benefit of superior insulation associated with foam substrates without the extra expense of adding a facing layer to the foamed substrate.

### INVENTION SUMMARY AND REVIEW OF PRIOR ART

Many foamed thermoplastic resins possess insulating qualities that render these foamed resins useful in building and construction applications. One such application is the use of foamed thermoplastic resin sheets, boards, or panels as a component of built up roofs. Built up roofs are used for new construction as well as for restoration and remodeling of existing roofs. Built up roofs having foamed substrates are typically produced in several steps. First a layer of foamed resin is formed on top of an existing roof surface or underlayment. For new construction, the roof surface would be any acceptable roof underlayment. For reconstruction, the surface may be the same as for new construction or may be the surface of the original unimproved roof. In theory, it may be possible to produce a monolithic foam resin layer in situ particularly in instances where the roof has little or no slope. Normally, however, the foam resin layer is formed from a plurality of foam panels, sheets, or boards that are secured to the roof underlayment by suitable means. Built up roofs are subsequently completed by applying hot asphalt, in the molten state, and roofing felt or a similar material in alternating layers to the exposed surface of the foamed resin layer having the desirable insulating properties. Upon cooling, the layer or layers of asphalt and roofing felt form a waterproof and weather resistant finish to the surface of the built up roof that is exposed to the elements. The combination of insulating properties gained from the foam resin layer and weather resistant properties gained from the asphalt and roofing felt has served to make the use of built up roofs a very popular system for finishing roofs.

In spite of the commercial acceptance of built up roofs, there are limitations to such systems that result in higher labor and material costs. Also, these same limitations frequently cause the roofs to score poorly in standardized tests used for rating the quality of such roofs, and in particular on ASTM D 1623 rev., known as the Asphalt Adhesion Uplift test. The most significant problem is that commercially viable foamed resins are not suitable for the direct application of hot asphalt in built up roofing applications. Asphalt used in built up roofs often is heated to temperatures of about 260° C. Direct application of asphalt heated to these temperatures and then applied to prior art thermoplastic resins often results in severe thermal degradation and deformation of the foamed resins. Also prior art foam resins degrade chemically upon direct application of hot asphalt because of the solvent like hydro carbonaceous materials present in the asphalt. The ebullition of gas upon direct application of hot asphalt to a foamed thermoplastic resin roof substrate is an obvious indication of failure of the foamed resin to accept the hot asphalt application.

One method used to improve the heat and solvent resistance of prior art foamed resins is to face the foamed material with a material having superior thermal and chemical resistance. In the simplest facing method, an adhesive that is chemically compatible with the foamed insulating product is applied directly to the foamed product with the first layer of roofing felt or similar material being laid over the adhesive before it sets. Often, hot asphalt can be applied to this first layer of roofing felt without thermal or chemical degradation of the foam resin layer. In typical installations, the asphalt layer serves as the adhesive for another layer of roofing felt. The process of alternating layers of asphalt and roofing felt is continued until the desired roof properties are obtained. Regardless of the number of roofing felt and asphalt layers applied, it is typical to complete the built up roof process by applying a final thicker layer of asphalt as the finish layer. This final layer of asphalt is often referred to as the “flood layer” and is normally thicker than the tie layers of asphalt between the roofing felt layers. While this method of attaching the first layer of roofing felt to the foam layer with an adhesive can reduce the thermal and chemical impact of hot asphalt on a foamed underlayment, the method is not preferred because application of the adhesive increases labor and material costs.

More complex facing methods involve facing a foamed thermoplastic resin material with a facing membrane as one of the final steps in the manufacture of the insulating foamed resin material. This method places an extra cost burden on the process of manufacturing the insulating foamed resin, but produces an insulating board or sheet suitable for the direct application of hot asphalt at the roof construction site. The hot asphalt is applied to the facing material on the foam, i.e., not directly to the foam resin. Examples of foamed, faced, thermoplastic resin insulating sheets may be found in U.S. Pat. Nos. 3,466,222 and 4,965,977. While pre-faced foam panels are easier to use at the job site, the process of manufacturing faced materials is obviously more complex and cost intensive than the production of simple un-faced foamed insulating materials.

A second method for increasing the utility of foamed thermoplastic insulating building materials in built up roofing applications requires producing foamed thermosetting resin materials having improved heat and solvent resistance. An example of this approach is described in U.S. Pat. No. 3,672,951 to Moore, et al. Moore teaches the use of a foamed, thermoplastic insulating material made from 85 to 65 weight percent styrene and 15 to 35 weight percent maleic anhydride. While Moore claims that his foamed materials possesses improved temperature resistance, his experimental data show that each of his compositions fails a coal tar pitch application test at application temperatures of no more than 270° F. (132° C.). While Moore's material may be superior to previously known foamed thermosetting resin insulating materials, his material appears to be unsuitable for direct application of hot asphalt at temperatures in the vicinity of about 260° C. (500° F.) which are typically employed in modern built up roofs constructions using the preferred asphalts.

In addition to thermal and chemical resistance, other physical properties of the foam insulating materials used in built up roofing applications are also important. Some of the additional important properties for the foamed material include compressibility, flexibility, thermal coefficient of linear expansion, dimensional stability, and properties related to water absorption. Other important properties such as uplift and shear strength are related to the bonding of the asphalt to the foamed material and are extremely relevant to the suitability of a foamed material for use in built up roofing systems. Of these additional properties, the adhesive uplift resistance of the asphalt/foam interface is of critical importance, as insurance rates are typically predicated on the adhesive uplift characteristics of an installed roof.

This invention discloses compositions and methods of use comprising hot asphalt directly applied to the surface of the foam substrate typically at temperatures of about 500° F. (260° C.) and possibly slightly higher. The compositions and methods of this invention are superior in that the combined hot asphalt foam compositions, composites, and methods are achieved without the need for the intermediate facing layer required by the prior art and substantially with no thermal or chemical degradation of the foam substrate. The foamed substrate insulating materials of this invention form a strong bond with the directly applied hot molten asphalt, particularly against uplift forces, while providing good flexibility and compressive characteristics and minimal thermal expansion and water absorption qualities. The advantages realized are less material costs, lower labor costs, and superior roof performance as measured by standardized tests typically applied to such roof constructions.

More specifically, in one embodiment, this invention involves preparation of a composite material comprising a thermally resistant foamed polyester resin substrate to which has been directly applied a layer of hot melt sealant in the molten state at temperatures in the range of about 135- 260° C. substantially in the absence of degradation of the foam

In another embodiment, this invention provides a method for forming a built up roof without the need to isolate the foam layer of the roof from the detrimental effects of the application of hot melt sealant to the surface of the foam. In one embodiment, a method for application of hot melt sealant in the range of about 135 - 260° C. at the job site has been provided. This method involves construction of a built up roof via the following steps:

(a) securing a layer of a foamed polyester resin of this invention to an unimproved roof surface by suitable attachment means such as nails, screws, staples, or adhesives;

(b) applying a layer of hot melt sealant in the molten state at temperatures in the range of about 130 - 260° C. directly to the exposed surface of said foam layer substantially in the absence of degradation of the foamed resin;

(c) optionally applying a layer of roofing felt to the unset hot melt sealant layer;

(d) optionally applying additional alternating layers of hot melt sealant and roofing felt, preferably ending with a layer of hot melt sealant; and

(e) solidifying the sealant layer and optional additional sealant layers by permitting the sealant to cool forming a weather resistant, insulated sealed roof.

This method further serves to define in its embodiment a laminar composite comprising a base layer of foamed polyester resin to which has been directly applied a hot melt sealant in the molten state at temperatures in the range of about 130 - 260° C. wherein said hot melt sealant application occurs substantially in the absence of any degradation of the foam. The laminar composite further comprises a layer of roofing felt attached by the hot melt sealant and may further comprise optional additional alternating layers of hot melt sealant and roofing felt. The laminar composite is generally completed with a final and thicker layer of hot melt sealant to which is optionally added a finishing layer of particles such as washed gravel or crushed marble.

### BRIEF DESCRIPTION OF THE DRAWINGS

FIG. 1 shows a typical built up roof structure using the compositions and methods of this invention.

FIGS. 2A through 2C show special features that may be incorporated into the foam panel edges during or after manufacture of the panels to improve the interlocking of and overlaying of the foam panels which make up the foamed substrate layer of the improved built up roofs of this invention.

### DESCRIPTION OF THE INVENTION

It should be noted that the term “comprising” is used frequently throughout the description of this invention and also in the appended claims. “Comprising”, as used in this application and the appended claims is defined as “specifying the presence of stated features, integers, steps, or components as recited, but not precluding the presence or addition of one or more other steps, components, or groups thereof”. Comprising is different from “consisting of”, which does preclude the presence or addition of one or more other steps, components, or groups thereof.

A major concept in this invention is the disclosure of novel insulating and weather resistant materials and composites comprising the combination of heat resistant polyester foam resins to which have been directly applied hot melt sealant in the molten state at temperatures in the range of 135 - 260° C. substantially in the absence of any degradation to the foamed resin. Commonly assigned U.S. Pat. Nos. 5,340,846 and 5,288,764 provide detailed description for the preparation of the foamed polyester resins that constitute the foam resin moieties of the new compositions and composites of this invention. Both U.S. Pat. Nos. 5,340,846 and 5,288,764 are hereby incorporated by reference in their entirety. The excellent thermal properties of the polyester foams disclosed in U.S. Pat. Nos. 5,340,846 and 5,288,764 are believed to be related to several factors including (1) the employment of high levels of branching agent sufficient to produce the desired thermal resistance of the foamed polyester resin, (2) the near complete absence of unreacted branching agent in the polyester foam wherein the amount of unreacted branching agent in the polyester foam product is less than about 100 ppm, and (3) the special processing during production of the polyester foam wherein the foamed polyester resins are formed using concentrates.

The foamed polyester resins of this invention are typically fabricated using unmodified polyester, a blowing agent, concentrate (A) and, optionally concentrate (B), wherein concentrate (A) comprises polyester and about 0.2 to about 15 wt % branching agent and wherein concentrate (B) comprises polyester and about 0.1 to about 10 wt % nucleating agent. In a typical foam resin fabrication, the unmodified polyester is deployed in the range of about 85 to about 99.8 wt % of the product resin, the blowing agent is deployed in the range of about 1 to about 15 wt % of the feed, concentrate (A) is deployed in the range of about 0.2 to about 10 wt % of the product resin, and concentrate (B) is deployed in the range of 0 to about 6.7 wt % of the product resin. In a typical formulation, the final foam resin will be comprised of branching agent in the range of about 0.2 to about 1.0 wt % and nucleating agent in the range of 0 to about 2.0 wt %.

The preferred polyesters of this invention are those that comprise at least some polyethylene terephthalate (PET) repeating units and/or at least some polyethylene naphthalate (PEN) repeating units with the provision that some or all of the alkylene moieties of the PET or PEN may consist of propylene or butylene. More succinctly stated, the preferred polyesters of this invention are those that comprise repeating units selected from the group consisting of those encompassed by Formula I and Formula II below and wherein n in each of Formulas I and II has a value in the range of2-4.

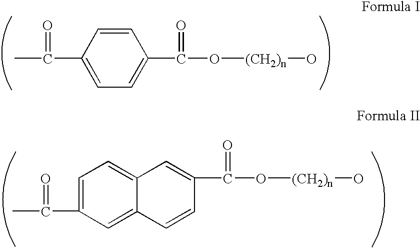

The term “branching agent” as used herein is intended to encompass polyfunctional compounds that react with polyesters to produce branching thereof. Included among the suitable branching agents is trimellitic anhydride. Preferred in the present invention, in view of their ability to form gel-free concentrates, are branching agents having two or more anhydride groups per molecule. These include both aromatic and non-aromatic anhydrides having two or more anhydride groups per molecule. Pyromellitic dianhydride is particularly preferred because it is a relatively inexpensive, commercially available material that reacts quickly with the polyester resin.

There is nothing particularly critical to this invention regarding the choice of blowing agents used for foaming the polyester resin except that the blowing agent should be compatible for use with polyester at the temperatures employed. Acceptable blowing agents include nitrogen, carbon dioxide, butane, pentane, freon 152A, freon 134A and combinations thereof. The preferred nucleating agent for the foam resins of this invention is sodium carbonate (Na₂CO₃).

Other materials and additives may also be present in the final foam resin product in minor amounts. For example, it is known (see U.S. Pat. No. 5,288,764) to add some polystyrene to the polyester foam resin as an extrusion aid. In one embodiment, polyester foam resin scrap of this invention is used as part of the polyester feed in production of the polyester foam resins of this invention. Scrap from the polyester foam resins of this invention would also contain branching agent and optionally nucleating agent originally formulated therein. In other embodiments, polyester foam resin scrap from other sources comprises part of the resin feed and will contain other additives and agents in minor amounts that were formulated therein. Also, employment of typical resin additives such as fire retardants, flame retardants, antioxidants, colorants, stabilizers, fillers, and mixtures thereof are envisioned for other embodiments of the polyester foam resins of this invention.

In practice, especially for production runs, the polyester foam resins are produced in a reaction extruder and then made into convenient sized panels having typical dimensions in the ranges of about 0.25 to about 4 inches thickness and typically cut into 4′×8′ panels. In one embodiment, a layer of hot melt sealant is applied directly to the foam panels as part of the process for manufacturing the foam. This embodiment is especially useful for foam resins and asphalts where more precise control of the temperature of the first layer of the hot melt sealant is needed than could be achieved at the roof job site. In more typical embodiments, however, the hot melt sealant is more advantageously applied at the job site. Foam panels pre-coated with hot melt sealant during fabrication still require the application of hot melt sealant in order to provide an adhesive tie layer for the first layer of roofing felt.

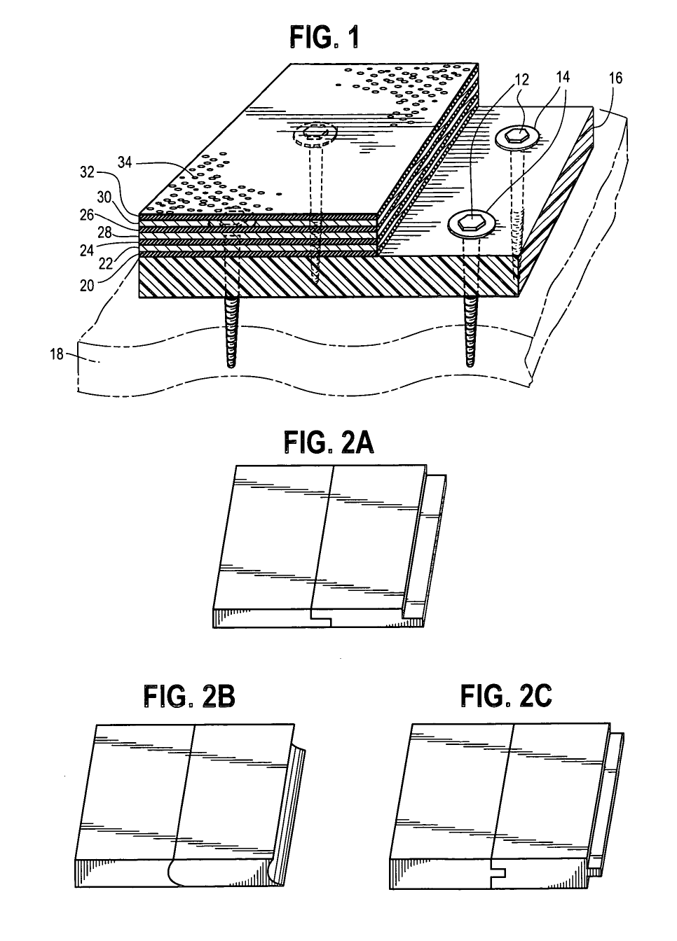

A basic embodiment for the foam panels and their use in built up roofs is shown in FIG. 1 where the panels employed are rectangular prisms. Referring further to FIG. 1, screws 12 pass through optional wide washers 14 piercing foam substrate panel 16 and attaching it to unimproved corrugated metal roof underlayment 18. Initial asphalt tie layer 20 is formed from hot asphalt spread, at temperatures of about 260° C., over panel 16, screws 12, and washers 14. Initial roofing felt layer 22 is applied over the initial asphalt tie layer 20 before it sets. Optional asphalt tie layers 24 and 26 and optional roofing felt layers 28 and 30 are added, if desired, in a manner similar to that used for the initial asphalt layer and roofing felt layer. Final asphalt flood layer 32 is formed from hot asphalt spread, at temperatures of about 260° C., over the final roofing felt layer and is typically thicker than the thickness of previously applied asphalt tie layers 20, 24, or 26. Optional pea gravel layer 34 is spread, typically at ambient temperatures, over final asphalt flood layer 32 generally before layer 32 has completely cooled and solidified. The laminated composite formed by the embodiment of FIG. 1 is novel in that it has not previously been disclosed or made obvious since the concept of direct application of hot melt sealant, at temperatures in the range of about 135° C. to about 260° C., directly to the foamed thermoplastic substrate layer was previously unknown.

In other embodiments, the sides of the foam panels have special shapes and/or features, which improve the overlap of the panels with one another or which more effectively lock the panels together serving to make the foam layer more monolithic. FIGS. 2A through 2C show additional embodiments of the foam panels which incorporate special shapes and features on the panel sides. FIGS. 2A - 2C show these special shapes on only two sides of the panels, but in practice the special shapes would be applied to all four edges of the panels to increase the interlock of the panels. These special shapes may be incorporated into the panels as part of the fabrication process or may be added later using ordinary engineering skills. The embodiments of FIGS. 2A-2C show the foam panels aligned but panels are more typically deployed in a staggered pattern when forming the foam substrate layer of a built up roof.

The foam panels may be secured to the roof underlayment by any convenient means. FIG. 1 shows an embodiment where the panels are mechanically attached to the roof underlayment with screws and large washers. In the instance of FIG. 1, the roof underlayment is a corrugated metal sheet. Depending on the nature of the underlayment material, the foam panels may also be attached by nails, staples, studs, etc., or a combination of mechanical means. In other embodiments, the foam panels are adhesively secured to the roof underlayment by means of a suitable and compatible adhesive. Alternatively, the adhesive could be in the form of a double-sided adhesive tape used between the foam panels and the roof underlayment. Other embodiments entail the use of both mechanical and adhesive means for attachment of the panels to the roof underlayment. The embodiment of FIG. 1 shows the foam panels attached only to the roof underlayment. In other embodiments the panels may be additionally optionally attached to each other by suitable mechanical or adhesive attachment means. Suitable mechanical attachment means includes pins, dowels that mutually penetrate adjacent panels, studs, brackets, clips, joiners, springs, and similar fasteners that would serve to lock the panels together into a more monolithic structure. Adhesive means includes not only the simple use of compatible adhesives along the edges of the panels but also envisions the use of adhesive tapes overlapping adjacent panels where they abut one another. The use of double-sided (double sticky) adhesive tape along the panel edges is also envisioned.

Generally, the polyester foam resin panels will have the hot melt sealant applied directly to their surfaces with out additional processing. It is well known in the foam art area, however, to treat the surface of foam in order to change its characteristics. For example, foam surfaces are often heat treated with steam or radiation to form a more resistant crust or skin on the foam or to close the cells at (or near) the surface of the foam. Foams are often treated with radiation or chemically to change the characteristic of the foam surface so that the foam is more compatible with or more receptive to adhesives and sealants that may subsequently be applied to the foam surface. It is also know to treat a foam surface mechanically, for example, with an abrasive agent, so as to compatibilize the surface for subsequent application of an adhesive or sealant. Those of ordinary skill in the foam art will recognize such surface treatment of the foam as only the application of typical engineering skills and accordingly such treatments of the foam surface are within the scope and spirit of this invention.

The hot melt sealants moiety of the new compositions and methods of this invention are well-known, commercially available products. For the purposes of this invention, a hot melt sealant is defined as a material which is easily liquefied at relatively low temperature so that it can be poured or spread and which sets on cooling to form a strong and permanent layer and bond. Any hot melt sealant meeting the requirements for built up roofs may be used provided that it becomes a spreadable liquid at temperatures in the range of 135 - 260° C. Because of cost and availability considerations, the preferred hot melt sealants for this invention are pitch, tar, asphalt, and combinations thereof.

For the purposes of this invention, pitch is defined as a carbonaceous residue left from the distillation of substances such as coal tar, pine tar, rosin, petroleum and fatty acids or as a naturally occurring substance having properties similar to the distillate residues already recited. In a similar manner, tar is defined as the residue left from the destructive distillation of carbon rich materials such as coal, wood, and petroleum or as a naturally occurring substance having properties similar to the destructive distillation residues recited. Asphalt is defined as a thick viscous mixture of hydrocarbons (bitumen) obtained chiefly as the residue of petroleum distillation but also occurring naturally. For this invention the term “asphalt” encompasses not only asphalt as defined above but also filler containing asphalt.

The hot melt sealants of this invention may also optionally comprise typical additives such as fire retardants, flame retardants, antioxidants, colorants, stabilizers, fillers, and mixtures thereof. Also, in one embodiment weather resistant particles such as washed gravel (pebbles) or chipped marble are spread over the final hot melt sealant layer (flood layer) exposed to the elements. In such an embodiment, these particles are typically applied before the final hot melt sealant layer is completely solidified. The particles serve not only a cosmetic purpose but also increase the weather resistance of the hot melt sealant flood layer of the built up roof.

The hot melt sealant may be applied in a spreadable state directly to the polyester foam resins of this invention to form the novel compositions, composites, and methods of this invention by any convenient process including but not limited to pouring, spraying, brushing, rolling, squeegeeing, sponging, swabbing, and mopping. When the hot melt sealant is applied to individual foam panels prior to installation on the roof, dipping the panels in hot melt sealant constitutes a convenient method of applying the hot melt sealant to the foamed polyester resin.

In forming the novel compositions, composites, and methods of this invention, the application of a hot melt sealant in the temperature range of about 135+ C. to about 260° C. directly to a foamed thermoplastic resin is a key concept. As noted previously, this direct application of the hot melt sealant to the foamed resin must be achieved substantially in the absence of degradation of the foam in order to have utility and be within the spirit of this invention. Obviously, the congealed mass typically resulting from the application of hot melt sealant, in the temperature range of about 135° C. to about 260° C., to prior art foamed resins has no utility in terms of application in built up roofs and related applications of this invention. Only the application of hot melt sealant, in the temperature range of about 135° C. to about 260° C., to foamed resins substantially in the absence of degradation of the foam are of interest and within the spirit and scope of this invention. For the purposes of this invention, application of hot melt sealant to foamed thermoplastic resins substantially in the absence of degradation means that the dimensions and physical properties of the foamed resin sheet remain about the same as those values which were present prior to the direct application of the hot melt sealant. More specifically, substantially in the absence of degradation means, in part, that under similar measuring conditions, length, width, and diagonal measurements of a rectangular foamed resin sheet directly coated with hot melt sealant shall remain within two percent of the corresponding measurements prior to application of the hot melt sealant. A further requirement of the definition of substantially in the absence of degradation of the foamed resin is that there shall be no noticeable ebullition of gas during the application of the hot melt sealant directly to the foamed resin. A still further requirement of the definition is that under similar conditions, the weight and density of the foamed resin sheet after application of the hot melt sealant shall both be within two percent (after correction for the weight of the dried asphalt and the thickness of the asphalt layer) of the original values prior to application of the hot melt sealant to the foamed resin sheet.

### EXAMPLES

### Fabrication Of Mocked Up Roofs

Roofing trials were conducted at American Roofing and Repair Company in West Chicago, Illinois. In these trials, five materials were made into mocked up roof decks approximately 4 feet by 4 feet each. One of the mocked up roofs was constructed from the polyester foam resins of this invention. The other four mocked up roofs were constructed from materials which were touted as capable of withstanding the direct application of hot asphalt or which were already well established in roofing construction.

All five mocked up roofs were constructed using the same degree of mechanical fastening to secure the roof panels to the roof underlayment as was used for the foam resin panels of this invention or were fastened to the underlayment in accord with manufacturers' specifications therefor. The roof underlayment in all cases was 4′×4′×1″ thick plywood attached to 2″×4″ runners for dimensional support from warping. A one-inch aluminum drip edge was nailed around the exterior edges of the mocked up roofs test decks to minimized weathering from the edges of the test decks once completed. The mocked up roofs were all shimmed to the same angle (simulating roof slope) and were aligned in a row on sheets of plywood. Each of the mocked up roofs was hot mopped with asphalt followed by application of a layer of roofing felt. This procedure was performed three times for each of the mocked up roofs in a continuous manner (as would be the normal operation at a roofing job site) to build up three plies of felt with alternating tie layers of asphalt. Type IV fiberglass roofing felt impregnated with asphalt was used in all cases. Trumball Type IlIl asphalt (often used on flat roofs) was used. This asphalt has a softening point in the range of 85 - 96° C. (185 - 205° F.). The equiviscous temperature (EVT) of asphalt is the temperature range at which the asphalt is at ideal fluidity for application. For Trumball Type IlIl asphalt, the EVT is 235 C. ±14° C. (450° F. ±25° F.). The asphalt kettle temperature should be at least 14 C. hotter than the EVT to allow for cooling that may occur during transfer of the hot asphalt from the heating kettle to the roof surface. On the day of the tests, the hot asphalt kettle temperature was measured and found to be about 274 C. (525° F.). This temperature was slightly higher than desired. However, the outside temperature was −1° C. (30° F.) and may have cooled the hot asphalt more than might normally be expected during transfer from the kettle to the roof on a warmer day.

In all cases, the built up roofs were started by application of the asphalt directly to each of the mocked up roofs substrate materials in sections approximating the width of the roofing felt followed by application of the roofing felt to the asphalt coated section. This process was repeated until the mocked up roofs were completely coated with asphalt and roofing felt. In a similar manner and as noted above, two more tie layers of asphalt and two additional plies of roofing felt were applied to each of the mocked up roofs without any stoppage of work. After application of the three layers of asphalt and three layers of roofing felt, the mocked up roofs were permitted to cool enough so that they could be separated from one another. After separation, the mocked up roofs each received a flood coat of asphalt and a layer of pea gravel (1/4 inch washed pebbles). The final layer (so called “flood layer”) of asphalt was applied using a spouted container to pour a thick layer of asphalt on the mocked up roofs followed immediately with a layer of pea gravel which was shoveled and spread on the hot asphalt to remain imbedded therein. The target amount of asphalt for built up roofs and for these tests was 30 pounds per 100 square feet of roof for the tie layers of asphalt and 60 pounds per 100 square feet of roof for the flood layer of asphalt. Over the next several weeks a series of tests well know in the roofing art area were conducted on each of the completed built up roofs that resulted from the mock-ups described above.

### Example 1

For Example 1, a polyester foam resin formulation of this invention was used as the insulating and inner substrate layer material of the mocked up roof as described previously. A description of the manner of fabrication for the polyester foam resin of Example 1 follows. The polyester employed was PET (Shell's 7207) at a rate of 95.83 weight percent of the final foam resin. Concentrate A was employed at a rate of 3.50 weight percent of the final foam resin and consisted of 10 weight percent pyromellitic dianhydride and 90 weight percent PET. Concentrate B was employed at a rate of 0.67 weight percent of the final foam resin and consisted of 3 weight percent Na₂CO₃ and 97 weight percent PET. These three entities were fed into a system comprising a 4.5″ extruder followed by a gear pump and a 6″ extruder. Freon 142B was used as the blowing agent at a rate of 5 weight percent of the total feed and was introduced through an inlet port about midway into the first extruder. The feed rate was about 400 lbs per hour and the reactor extruder temperature was maintained in the range of about 269 C. to about 273 C.

Two parallel plates abutting the final extruder die exit were used to shape the extruded PET foam into sheet material that was 1″ thick and 1′ wide. The plates were coated with a non-stick surface and were cooled. The sheet was pulled by a conventional belt puller and cut into 8′ lengths using a traveling up-cut circular saw. Air-cooling was provided at many points between the die exit and the saw to stabilize the foam. By varying conditions, foam panels having densities between 0.03 and 0.3 grams/cc can be produced. The foam panel made for Example 1 had a density of 0.077 grams/cc (4.8 pounds/cubic foot). The mocked up roof of Example 1 was made from these 1-inch thick and 1-foot wide panels. Normal production run panels are produced having a thickness in the range of about 0.25 inches to about 4 inches and typically cut into 4′×8′ panels. A recommended nailing pattern for 4′×8′ foam panel sections has been determined. However, a special nailing pattern was used for the mocked up roof of Example 1 because of the unusual (narrow) 1-foot width of the panels. The special nailing pattern was designed to provide the strength equivalent to the recommended nailing pattern for 4′×8′ production run panels. Many laboratory scale tests have been conducted on various formulations of the novel compositions of this invention which comprise the thermally resistant polyester resins to which has been directly applied a coating of hot asphalt at temperatures up to 260° C. (500° F.). While these novel compositions performed outstandingly in laboratory testing in that the application of hot asphalt did not substantially (as previously defined) degrade the foamed resins and that the adhesion of the asphalt to the foam was excellent, it was felt that the equivalent of a field test was needed, even if for no other reason than to compare the novel compositions, laminar composites, and methods with other known and competing materials and methods. Thus the mocked up roof tests were performed to gather data that would confirm the advantages of the compositions, composites, and methods of this invention over competing and known compositions and methods.

### Example 2

For Example 2, the mocked up roof substrate layer was constructed of Celotex's HYPOTHERM which is a one inch thick polyisocyanurate roofing insulation board having a density of about 1.9 pounds per cubic foot.

### Example 3

For Example 3, the inner substrate layer of the mocked up roof was constructed of Celotex's HYPOTHERM AP which is a product similar to the material of Example 2 except that is has wood fiber facers (each about 50 mils thick) on both sides of the sheet. The density of this material with the facings is about 3.1 pounds per cubic foot. This product has been designed to be applicable for direct hot asphalt mopping.

### Example 4

For Example 4, the inner substrate layer of the mocked up roof was constructed as in Example 3 except that the top surface of Celotex's HYPOTHERM AP product was covered with a cap-sheet. The cap-sheet used was FESCO board which is a 0.75-inch thick perlite/fiber product made by Manville. It has a minimum density of 9.0 pounds per cubic foot by itself and a combined density of 5.0 pounds per cubic foot when used as a cap-sheet in combination with HYPOTHERM AP. The FESCO board cap-sheet was attached as a cap-sheet overlaying the HYPOTHERM AP sheet by using a nailing pattern recommended by Celotex for applications where FESCO board is used as a cap-sheet with HYPOTHERM AP.

### Example 5

For Example 5, the inner substrate layer of the mocked up roof was constructed of wood fiberboard that was 0.75 inch thick. Wood fiberboard is a common building material sometimes used as an alternative to plywood and also often used in built up roof constructions. It is comprised of wood and/or sugar cane fibers impregnated and coated with asphalt. The wood fiberboard used for Example 5 met the ASTM Type I roof board standards.

### Testing Of Mocked Up Roof Examples

Mocked up roofs Nos. 1 - 5 constructed from substrate layers of materials of Examples 1 - 5 respectively were subjected to a series of tests and measurements typically used on such materials and typical of built up roof constructions. It should be noted that when hot asphalt at about 525° F. was applied to the Celotex HYPOTHERM and HYPOTHERM AP mocked up roofs (Examples 2 and 3), extensive bubbling and release of gas was observed indicative of degradation of these materials. The mocked up roof of HYPOTHERM AP cap-sheeted with FESCO board (Example 4) showed no such gas release and appeared to receive the hot asphalt without problems. The wood fiberboard of Example 5 also appeared to receive the hot molten asphalt with no problems.

The results of the parameters measured are summarized in Table 1. In some instances the values given are those reported in the product specification for commercially available products and are not measured values. These reported values are so designated in Table 1 as appropriate. The data in Table 1 clearly demonstrate that the compositions and methods of this invention showed the same outstanding performance in the mocked up roof tests as they had shown in smaller scale laboratory work. Although not exemplified in this disclosure, it will be obvious that many roofing materials, including those of Examples 2 - 5 below, would benefit by inclusion of a cap sheet of the PET board of this invention so as to be able to directly receive a hot asphalt application.

TABLE 1

| | Example Number | | | | |
|---|---|---|---|---|---|
| | 1 | 2 | 3 | 4 | 5 |
| Mocked Up Roof | PET | HYTHERM | HYTHERM | FESCO | WOOD FIBER |
| Material | Board | w/o facers | w/facers | Board | Board |
| Density | 4.8 | 1.8 | 3.3 | 10.4 | 21.2 |
| pounds/cubic foot | | | | | |
| Compression | | | | | |
| (ASTM D 1621) | | | | | |
| Modulus psi | 1740 | 834 | 611 | 1371 | 642 |
| Strength psi | 68 | 31 | 32 | 59 | 55 |
| 4-pt Flex Text | | | | | |
| (ASTM C 203) | | | | | |
| Modulus psi | 7952 | 1407 | 9340 | 12845 | 58781 |
| Strength psi | 280 | 54 | 136 | 65 | 306 |
| Coefficient of Thermal | | | | | |
| Linear Expansion | | | | | |
| (ASTM D 696) | | | | | |
| in/in/° F. (× 10⁵) | 3.7 | 12.5_{(reported)} | N/A | 10.0_{(reported)} | N/A |
| in/100 ft/100 deg F | 0.4 | 1.5_{(reported)} | N/A | 1.2_{(reported)} | N/A |
| R-value | 5.6 | 6.3_{(reported)} | N/A | 2.8_{(reported)} | N/A |
| Dimensional Stability | | | | | |
| (ASTM C 356 rev.) | | | | | |
| % Change Mach | −0.3 | +0.4 | +0.6 | −0.2 | N/A |
| 14 Hr/180° F.(X-Mach) | +0.5 | −1.0 | −0.1 | −0.8 | N/A |
| Asphalt Adhesion Uplift | | | | | |
| (ASTM D 1623 rev.) | | | | | |
| Strength psi | 67.0 | 29.4 | 19.0 | 7.6 | 11.8 |
| Double Lab Shear Test | | | | | |
| (ASTM C 961 rev.) | | | | | |
| Strength psi | 21.6 | 3.9 | 16.7 | 2.6 | N/A |
| Water Absorption (24 hr) | | | | | |
| % Wt. | 3.4 | 17.1 | 23.9 | 67.7 | 28.0 |
| % Vol. | −0.3 | 1.5 | 2.0 | 2.1 | 9.2 |
| Water Absorption (96 hr) | | | | | |
| (ASTM D 2842) | | | | | |
| % Wt. | 10.2 | N/A | N/A | N/A | N/A |
| % Vol. | 0.11 | 1.5_{(reported)} | N/A | 1.5_{(reported)} | N/A |

Examples 1 to 5 above illustrate the improved properties of the compositions and composites of this invention and the advantages of the methods of this invention. It will be understood by those of ordinary skill in the art that compositions, composites, and methods comprising the direct application of hot melt sealant to polyester foam resins at temperatures in the range of about 130° C. to about 260° C. are useful in a variety of constructions and other applications in addition to built up roofs, which, in spite of variations in composition, methodology and end use, will nevertheless embody and benefit from the present invention.

We claim:

1. Insulating and weather resistant materials comprising thermally resistant foamed polyester resin to which has been directly applied hot melt sealant in the spreadable molten state at temperatures in the range of about 130° C. to about 260° C. wherein said polyester comprises a thermally resisting amount of branching agent and wherein said application of hot melt sealant is made substantially in the absence of degradation of the foamed polyester resin.

2. The insulating materials of claim 1 wherein the branching agent is deployed in the range of about 0.2 wt % to about 1.0 wt % based on weight of the polyester foam.

3. The insulating materials of claim 2 wherein the amount of unreacted branching agent remaining in the polyester foam product is less than about 100 ppm.

4. The insulating materials of claim 1 wherein the foamed polyester resin is fabricated from polyester, a blowing agent, concentrate (A) and, optionally concentrate (B), wherein concentrate (A) comprises polyester and about 0.2 wt % to about 15 wt % branching agent and wherein concentrate (B) comprises polyester and about 0.1 wt % to about 10 wt % nucleating agent.

5. The foamed polyester resin of claim 4 wherein the polyester is deployed in the range of about 85 wt % to about 99.8 wt % of the product foam, the blowing agent is deployed in the range of about 1 wt % to about 15 wt % of the feed, concentrate (A) is deployed in the range of about 0.2 wt % to about 10 wt % of the product foam, and concentrate (B) is deployed in the range of 0 to about 6.7 wt % of the product foam.

6. The insulating materials of claim 4 wherein the nucleating agent is sodium carbonate.

7. The insulating materials of claim 1 wherein the branching agent is selected from the group consisting of trimellitic anhydride, non-aromatic anhydrides having at least two anhydride functional groups, aromatic anhydrides having at least two anhydride functional groups and mixtures thereof.

8. The insulating materials of claim 1 wherein the branching agent is pyromellitic dianhydride.

9. The insulating materials of claim 1 wherein the polyester comprises repeating units selected from the group consisting of those encompassed by Formula I and Formula II and wherein n in each of Formulas I and II has a value in the range of 2 - 4.

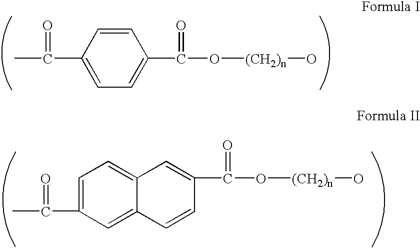

10. The insulating materials of claim 1 wherein the hot melt sealant comprises a member selected from the group consisting of asphalt, tar and pitch.

11. The insulating materials of claim 1 wherein the foamed polyester resin optionally also comprises typical additives selected from the group consisting of fire retardants, flame retardants, nucleating agents, antioxidants, colorants, stabilizers, fillers, and mixtures thereof.

12. The insulating materials of claim 1 wherein the hot melt sealant optionally also comprises typical additives selected from the group consisting of fire retardants, flame retardants, antioxidants, colorants, stabilizers, fillers, and mixtures thereof.

13. The insulating materials of claim 1 wherein the polyester optionally comprises scrap polyester and wherein said scrap polyester optionally further comprises agents and additives previously formulated therein.

14. The insulating materials of claim 1 comprising foam panels that optionally comprise special features on their sides to improve interconnecting with adjacent panels in forming a foam layer.

15. A method of producing a weather resistant and insulating roof comprising the steps of:
(a) attaching a layer of a foamed polyester resin of claim 1 to an unimproved roof surface by suitable attachment means;
(b) applying a layer of hot melt sealant in the molten state at temperatures in the range of about 130 C. to about 260° C. directly to the exposed surface of said foam layer substantially in the absence of degradation of the foamed polyester resin;
(c) optionally applying a layer of roofing felt to the unsolidified hot melt sealant layer;
(d) optionally applying additional alternating layers of hot melt sealant and roofing felt, preferably ending with a layer of hot melt sealant; and
(e) solidifying the sealant layer and optional additional sealant layers by permitting the sealant to cool forming a weather resistant, insulated sealed roof.

16. The method of claim 15 wherein the means for attaching the foam layer to the unimproved roof surface is selected from the group consisting of mechanical fasteners and adhesives.

17. The method of claim 15 wherein the polyester foam layer is formed from a plurality of foam panels.

18. The method of claim 17 wherein the foam panels optionally comprise special features on their edges to improve interconnecting with adjacent panels in forming the foam layer.

19. The method of claim 17 wherein the foam panels are further optionally mechanically or adhesively attached to adjacent panels in order to make the foam layer more monolithic.

20. The method of claim 17 wherein at least one surface of the foam panels is optionally treated by means selected from the group consisting of chemical treatment, thermal treatment, physical treatment, irradiation, and combinations thereof in order to improve the characteristics of the foam layer.

21. The method of claim 15 wherein weather resistant particles are optionally applied as a finish on the final optional exposed layer of the hot melt sealant.

22. A laminar composite comprising:
(a) layer (a) having a top and bottom side comprising the insulating material of claim 1 having foamed resin as the bottom side and hot melt sealant as the top side;
(b) layer (b) comprising roofing felt immediately adjacent to the top side of layer (a) and attached to layer (a) as a result of its placement thereon prior to setting of the hot melt sealant;
(c) optional additional alternating layers of hot melt sealant and roofing felt in the order recited atop layer (b) ending with a top final layer of hot melt sealant; and
(d) an optional finish layer of weather resistant particles applied atop the final layer of hot melt sealant.
